(19) United States
(12) Patent Application Publication
(10) Pub. No.: US 2006/0111881 A1
(43) Pub. Date: May 25, 2006

(54) Specialized processor for solving optimization problems

(76) Inventor: Warren Jackson, San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/995,665

(22) Filed: Nov. 23, 2004

(51) Int. Cl. G06F 17/10

(52) U.S. Cl. 703/2

(57) ABSTRACT

A specialized processor includes an objective function evaluator responsive to a state vector; and a solver, responsive to an output of the evaluator, for finding an optimal solution to the state vector. The processor can form a building block of a larger system.

### BACKGROUND

Specialized processors, optimized to perform commonly occurring tasks, are widely used in information processing systems. Examples of specialized processors include floating point processors, digital signal processors, and graphics chips.

A specialized processor can perform the same operations as a general purpose processor, but much faster. Consider a central processing unit (CPU) of a personal computer. The CPU orchestrates the operation of diverse pieces of computer hardware, such as a hard disk drive, a graphics display and a network interface. Consequently, the CPU is complex because it must support key features such as memory protection, integer arithmetic, floating-point arithmetic and vector/graphics processing. The CPU has several hundred instructions in its repertoire to support all of these functions. It has a complex instruction-decode unit to implement the large instruction vocabulary, plus many internal logic modules (termed execution units) that carry out the intent of these instructions.

The specialized processor is less complex than the CPU, it has significant speed advantages over the CPU, and it is smaller than the CPU. The specialized processor can have a slimmed-down instruction-decode unit and fewer internal execution units. Moreover, any execution units that are present are geared toward specialized operations. To help improve throughput, the dedicated processor may have extra internal data buses that help shuttle data among the arithmetic units and chip interfaces faster. Pipelined architectures reduce redundant steps and unnecessary wait cycles.

Functions of the specialized processor may be encapsulated. As an advantage, a system designed need not get involved in the intricacies of specialized problems. The designer need only specify the inputs.

The speed of computation of the specialized processor enables information systems to handle new applications and provides the systems with new capabilities. For example, graphics operations can be unloaded from a CPU to a graphics chip. Not only does the graphics chip reduce the computational burden on the CPU, but it can perform graphics operations much faster than a CPU. The graphics chip gives added capability to computer aided design, gaming, and digital content creation.

### SUMMARY

According to one aspect of the present invention, a processor is specialized to perform an optimization problem. According to another aspect of the present invention a specialized processor includes an objective function evaluator responsive to a state vector; and a solver, responsive to an output of the evaluator, for finding an optimal solution to the state vector. According to yet another aspect of the present invention, a system includes one or more of these specialized processors.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a specialized processor according to an embodiment of the present invention.

FIG. 2 is an illustration of the operation of the specialized processor during runtime.

FIG. 3a is an illustration of a solver for the specialized processor according to an embodiment of the present invention.

FIG. 3b is an illustration of a function evaluator for the specialized processor according to an embodiment of the present invention.

FIGS. 4a-4e are illustrations of different algorithms that can be used by a step generator of a solver.

FIG. 5a is an illustration of a system according to an embodiment of the present invention.

FIG. 5b is an illustration of an electrical equivalent of the system of FIG. 5a.

FIGS. 6-9 are illustrations of other systems according to embodiments of the present invention.

FIG. 10 is an illustration of an algorithm that is implemented by the system of FIG. 8.

### DETAILED DESCRIPTION

As shown in the drawings for purposes of illustration, the present invention is embodied in a processor that is specialized to solve an optimization problem. This optimization processor is configured with an optimization problem during setup or programming time. At runtime, the processor evaluates the optimization problem for different values of a state vector, and finds the value that provides an optimal solution. The processor may also evaluate the optimization problem subject to constraints.

The processor is readily adaptable to changes in operating environment, changes in goals, and changes in system capability, simply by changing input parameter vectors. Thus, the processor can be updated without getting involved in the intricacies of a specialized problem.

The optimization processor can solve an optimization problem much faster than a general purpose computer. Because of its greater speed, the optimization processor can enable new applications. Such applications include, without limitation, optimization of higher dimensional systems (e.g., systems in which multiple inputs are optimized), performance of complex objective functions, and optimization of systems subject to complex constraints.

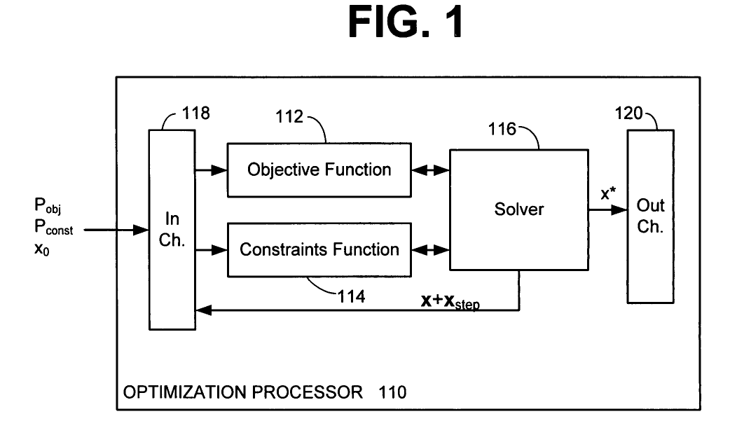

Reference is made to FIG. 1 which illustrates an optimization processor 110 for solving an optimization problem. The processor 110 defines a constrained optimization problem in terms of an objective function evaluator 112 and a constraints function evaluator 114. The objective function evaluator 112 is configured to evaluate an objective function, and the constraints function evaluator can be configured to evaluate a constraints function.

The processor 110 further includes a solver 116 for finding optimized solutions to the optimization problem during run time. The functions evaluated by the objective and constraint function evaluators 112 and 114 and an algorithm used by the solver 116 are application-specific. That is, they are selected according to the intended operation of the processor 110.

The processor 110 may be configured with the objective function and the constraints function at setup or programming time. The processor 110 also receives solver setup instructions. These instructions, such as a stencil of points for evaluating the objective function as described below, and code for specific algorithms, are used to configure the solver 116 at setup or programming time.

The processor 110 further includes an input channel 118. The input channel receives objective and constraints input vectors at runtime. The input vectors may include parameter vector inputs p_{obj} and p_{const} for the objective function and constraints function, respectively and an initial starting point x₀.

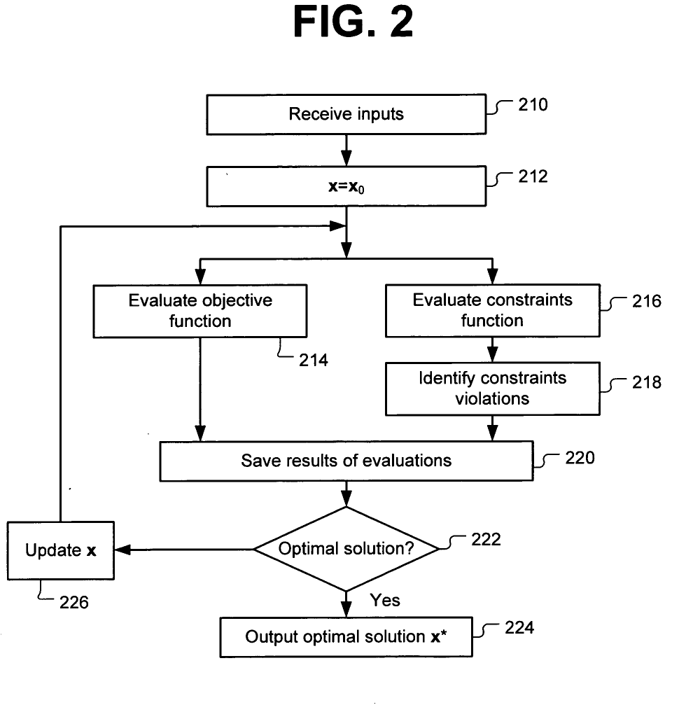

Additional reference is now made to FIG. 2, which illustrates an exemplary operation of the optimization processor 110 at runtime. At runtime, the optimization processor 110 receives the input vectors x₀, p_{obj} and p_{const} (block 210). The optimization processor 110 then sets state vector x to x=x₀ (block 212).

The objective function evaluator 112 evaluates the objective function for initial values of the state vector x (block 214). The objective function may also be evaluated as a function of the parameter vector p_{obj}. A value representing the evaluated objective function is supplied to the solver 116.

The constraints function evaluator 114 evaluates any constraints as a function of the state vector x and the constraint parameter vector p_{const} (block 216). A value representing the evaluated constraints function is supplied to the solver 116.

The constraints function evaluator 114 may also determine whether any constraints were violated (block 218). As an example of determining a constraints violation, the state vector x may be compared to a threshold. The results of the evaluation may also be used by the solver 116.

Results of the evaluations of the objective function and the constraints function are saved (block 220).

The solver 116 also determines whether the state vector x is optimal (block 222). The optimal vector x* might not be truly optimal, but it might be the best solution given certain limitations. For example, the processor 110 might have only a limited amount of time to find the best value for state vector x. Thus, the optimization processor 110 can continue to search for the best value of state vector x until time runs out. As another example, the optimization processor 110 might stop its search for the optimal vector x* if the improvement in the objective function is less than some specified convergence criteria (e.g., a relative change of 10⁻⁴).

If the updated state vector x is optimal, the optimal vector x* is sent to an output channel 120 of the optimization processor 110 (block 224). The optimal vector x* may be sent to the output channel 120, along with other outputs such as the value of the objective function at x* and p_{obj}, the value of the constraints function at x* and p_{const}, any violated constraints, any convergence information and other information related to optimization. The optimal vector x* can be feed back to the input channel 118 or routed to other specialized processors.

If the optimal value of the state vector x is not found, the solver 116 updates the state vector x (block 226). The state vector x may be updated, for example, according to previous results of evaluations and derivatives.

The updated state vector is sent back to the objective and constraints evaluators 112 and 114. The constraints function and objective function are evaluated in view of the updated state vector x (blocks 214-216), results of the evaluation are saved (block 220), and the solver 116 determines whether the value of the updated state vector x is optimal (block 222). The processing in blocks 214-222 and 226 continues until the optimal value for the optimal vector x* is found.

During runtime, the parameter vector inputs p_{obj} and p_{const} can be updated. Consequently, the constrained optimization problem can be solved as the parameter vector inputs p_{obj} and p_{const} are altered. These vectors should change slowly in comparison to the rate at which optimal or near optimal solutions x* are generated.

The optimization processor 110 can implement ‘hard’ and ‘soft’ constraints. Hard constraints are constraints that must never be violated. Collision avoidance among airplanes is such an example. Soft constraints are constraints that should not be violated but can be violated if the cost of the objective function is too great. Soft constraints can be implemented by including an additive term in the objective function that is proportional to the square of the constraint violation for each soft constraint. The importance of each constraint is established by the magnitude of the proportionality constant. Then optimization would require a tradeoff between a decrease of the primary objective against decreases in the constraint satisfaction for each constraint. Adjustment of the soft constraint violation during operation enables the optimization processor 110 (or the system at a higher level) to adjust constraint priorities during operation. For example, a walking robot could attempt to maximize speed in general but in the event of loss of balance, maintaining an upright posture could take precedence even if it entails backward steps.

The optimization processor 110 is not limited to any particular construction. As a first example, the processor 110 could include a first dedicated circuit for the objection function evaluator 112, a second dedicated circuit for the constraint function evaluator 114, and a third dedicated circuit for the solver 116. Each dedicated circuit may include a processing unit and memory that is programmed with functions and solver algorithms. For example, the objective and constraints functions, functions for evaluating the objective and constraints functions, and solver algorithms could be loaded from a library into memory during design. The first and second dedicated circuits could operate in parallel, and forward the results of the evaluations to the third dedicated circuit.

As a second example, the optimization processor 110 could include a single dedicated circuit including a single processing unit and memory. When invoked, such a processor would perform all three functions sequentially.

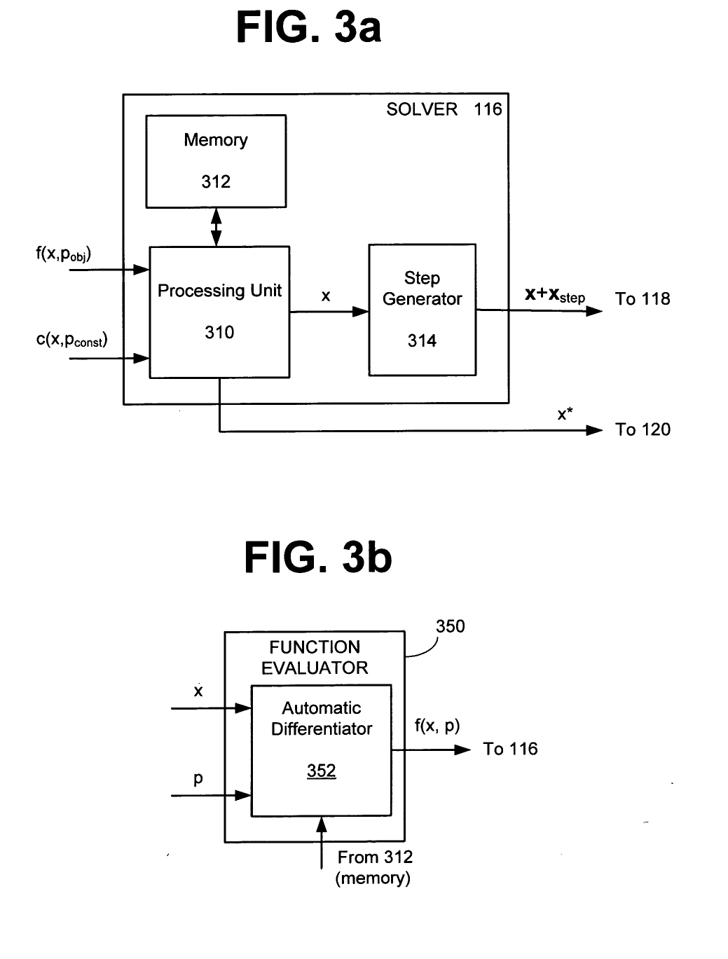

An example of a generic function evaluator 350 is illustrated in FIG. 3b. This function evaluator 350, which can be used for both the objective and constraints function evaluators, includes a dedicated circuit or optimized code 352 for performing automatic differentiation. Automatic differentiation generates a mathematically exact derivative of every floating point operation performed by a subroutine as a function of its inputs. Through the chain rule, the derivative of the outputs of the entire subroutine as a function of the inputs is computed. Thus, automatic differentiation generates accurate derivatives of continuous functions. The automatic differentiator 352 can use the evaluations of the objective function and the constraints function, which were saved at block 220. The automatic differentiator 352 can also use derivatives that are computed from these evaluations. Because derivatives are evaluated at the same time as the functions, intermediate results can be shared, thereby increasing efficiency of the optimization processor 110.

The input channel 118 may include bus, memory and analog-to-digital (ADC) for receiving inputs. The output channel 120 may include bus I/O, locations in main memory, I/O registers, etc.

The processor 110 can process a signal in real time. The initial starting point x₀ may be obtained by sampling a continuous signal. If the initial starting point x₀ is updated at the sampling frequency, the constraint optimization processor 110 finds the optimal value before the initial starting point x₀ is updated.

The processor 110 may be implemented as a FPGA, a digital signal processor (DSP) or Floating point processor type chip or an ASIC. Input and output channels of the dedicated processor may be on-chip or off-chip. A slower but more versatile implementation could be an optimized firmware for a general processor.

The architecture of the optimization processor 110 may be optimized in other ways. For example, the optimization processor 110 may maintain completely physically separate memory spaces for data and instructions so the fetching and execution of program code doesn't interfere with its data processing operations.

The objective function and constraint function evaluators could include a stack so that the constrained optimization processor could be used on several optimization problems simultaneously. The various functions and results are popped onto and off the stack as needed.

The data paths can be accomplished either by data busses or direct connections. As the band widths are not very large between processors, relatively inexpensive data channels could be implemented such as CanBus, RS-232, or Ethernet.

With such an architecture, the optimization processor 110 can perform automatic differentiation, perform optimized evaluations of an algorithm for a number of nearly identical input values (to get derivatives), optimized generation of random numbers, pipelined computation for single instruction, multiple data (SIMD) computations.

Reference is now made to FIG. 3a, which illustrates an exemplary solver 116. The solver 116 includes a processing unit 310, memory 312, and a step generator 314. The memory 312 stores a program that is executed by the processing unit 310. When executed, the program causes the processor 310 to find an optimal state vector.

The memory 312 is also used to store past values of the state vector x, and past results of the evaluations of the objective and constraint functions. The set of past values of the state vector x are denoted as {x₁, . . . , xₙ}. The set of past evaluations of the objective function are denoted as {f₁, . . . , fₙ}. The set of past evaluations of the constraints function are {c₁, . . . cₙ} Current values of the state vector and the functions are denoted as x₀, f₀ and c₀.

The processing unit 310 computes derivatives of the objective and constraint functions. The derivatives may be computed from current and previous values of the state vector, the objective function and the constraints function, For example, the derivatives may be computed by using the finite difference formula {f₁−f₂}/{x₁−x₂}. The derivatives of the objective and constraint functions are also stored in memory 312. The objective function evaluator 112 and the constraints function evaluator 114 could use these stored values to perform automatic differentiation.

The step generator 314 generates a cluster of new positions to evaluate the objective function and constraints. This cluster of new evaluation points plus pervious values are used to generate a step xₛₜₑₚ. A best guess for the next position, the step xₛₜₑₚ is added to the state vector x. The updated state vector x+xₛₜₑₚ is supplied back to the input channel 118 and then to the evaluators 112 and 114.

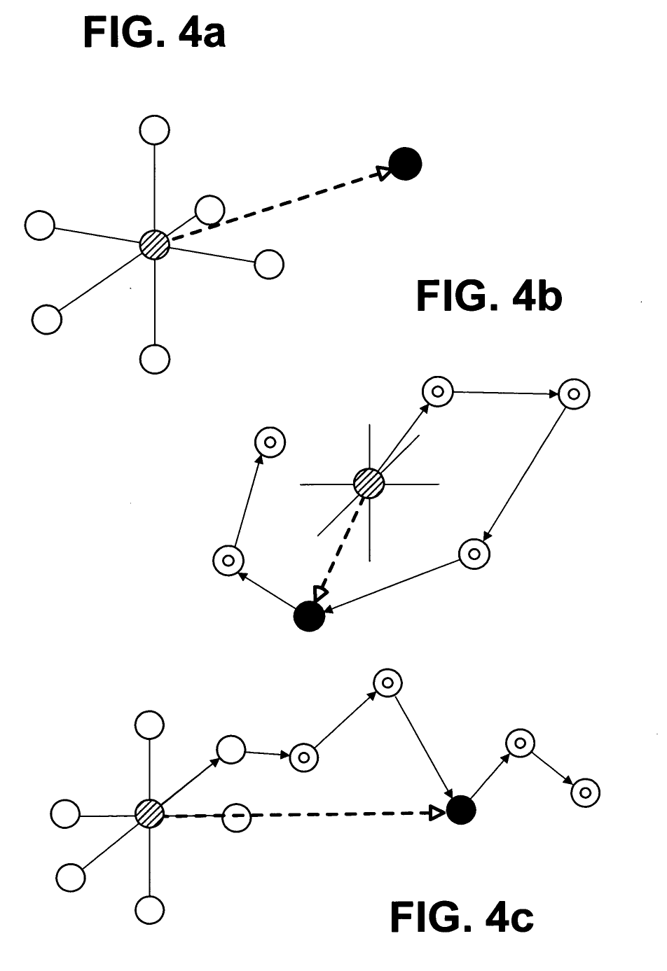

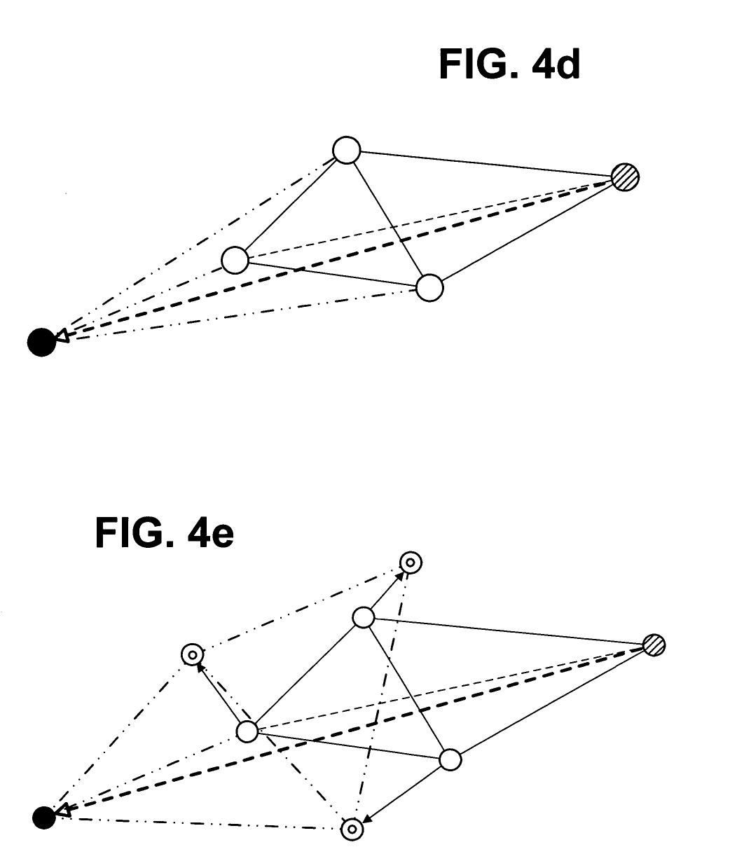

Several exemplary algorithms that can be used by the step generator 314 are illustrated in FIGS. 4a-4e. In these figures, each open (unfilled) dot represents a new state vector value. Together, these open dots represent a stencil of function values, that is, a cluster of values of the state vector in which to evaluate the objective function and constraint function in order to generate the best guess for a step that will yield a more optimal value of the state vector x and better satisfaction of the constraints. These open dots are interconnected by thin black lines without arrows, which represent the spatial array of computations (stencil) taken independent of each other.

Each cross hatched dot represents the old optimal solution. Each black-filled circle represents the next best feasible step actually taken. The open circles with dots at their centers represent the intermediate steps used to compute the best feasible step. The small solid lines with arrows denote computations taken in consecutive order. Each thick dashed line with unfilled arrow denotes the final computed step from the old best feasible solution to the next best feasible solution.

Various well known optimization algorithms are determined by the stencil pattern of evaluations and the resulting steps in improving the optimal solution. Thus, selection of the optimization algorithm determines the stencil pattern. For example, a Monte Carlo method uses a random stencil, a gradient method uses an orthogonal pattern, and a Nelder-Mead method uses a simplex pattern

FIG. 4a illustrates the stencil pattern that results in a combination of a Newton method and a Gradient Descent method. The cluster of points determines the gradient (derivative) of the objective function and an estimate of the curvature at the central point. These values can be used to make a best guess step shown by the dashed line. In the next iteration, the black filled circle becomes the cross hatched circle where a new cluster of points is determined based on the orthogonal stencil of points. This information obtained from this stencil and preceding stencils combined with a similar stencil for the constraints results in the Newton/gradient descent method. If the objective function and constraints are augmented with the dual problem to form a primal-dual constrained optimization problem, the gradient and curvature information can best be used in an interior point solver to find a best step for the new optimal point.

FIG. 4b illustrates the stencil pattern that results in the Monte Carlo method. The Monte Carlo method utilizes a random number generator to generate a sequence of random steps denoted by the sequence of arrows rather than a fixed step pattern. A random step is evaluated and accepted if it results in a lower value of the objective function while satisfying the constraints, and the random step is rejected with a certain adjustable probability that if the objective function is larger than the preceding value. After some number of steps, the rejection probability for steps that increase the objective function is decreased towards zero. This process, known as simulated annealing, finds a near global minimum even if the constrained optimization problem has a number of local minima.

FIG. 4c illustrates a Gradient-based or force-directed Monte Carlo method. The step actually taken is random step biased in the direction of greatest descent. The direction of greatest descent is determined by the orthogonal stencil of function evaluations.

FIG. 4d illustrates the stencil pattern for the Nelder-Mead method. The stencil is a simplex of points, a non-coplanar set of N+1 points in an N dimensional space. Based on the maximum value of the simplex, a step is taken away from this direction to replace the worst value (the cross-hatched circle) from the original simplex with a new best guess value (the filled circle). The step actually taken is the simplex direction for maximum improvement. The new simplex is represented in part by dot-dash lines.

FIG. 4e illustrates a Monte Carlo Nelder-Mead method. Monte Carlo steps are taken for each point in the simplex to find a local minimum. Then a Nelder-Mead simplex step is taken to generate a new best guess.

The solver 116 can quickly shift between algorithms by changing the step generation step stencil. For example, after taking a number of Newton steps towards a local minimum using the stencil pattern of FIG. 4a, the solver 116 could switch to one or more large Monte Carlo steps using the stencil in FIG. 4b and then revert back to the Newton method of FIG. 4a. The rate of improvement versus computational effort is monitored before and after the switch. If the switch in step pattern causes sufficient improvement in new solutions, the new step patterns are continued; otherwise alternative step patterns are implemented. Each method tends to get trapped by different regions in the optimization space. An advantage of switching stencil patterns is that it allows the system to escape a method that is trapped at a solution. The processing unit 310 can be responsible for setting the initial stencil pattern, determining when a method is trapped, and switching to a new method to escape a trap. Instead of using the processing unit 310 to escape traps, a state machine in the step generator could be used to transition to another method when the current method becomes trapped.

There is an advantage for the solver 116 performing automatic differentiation. Automatic differentiation can accurately implement the stencil pattern needed for gradient and Newton methods by providing gradient and curvature information. In automatic differentiation, the output of each elementary calculation within a subroutine is accompanied a calculation of the calculation's derivative with respect to its inputs. Through the chain rule for derivatives, the derivative of the outputs of the subroutine can be computed thereby providing all the evaluation points of the stencil in FIG. 4a with one pass through the objection and constraint evaluations.

The step generator 314 can be implemented in any combination of microcode, float gate arrays, high level software, or hardware. Hardwired automatic differentiation would generate a Newton stencil pattern (gradient/curvature) by one pass through the objective/constraint evaluation. Random number generation is computationally rather time consuming and performed so frequently that a hardware implementation would greatly speed up Monte Carlo routines.

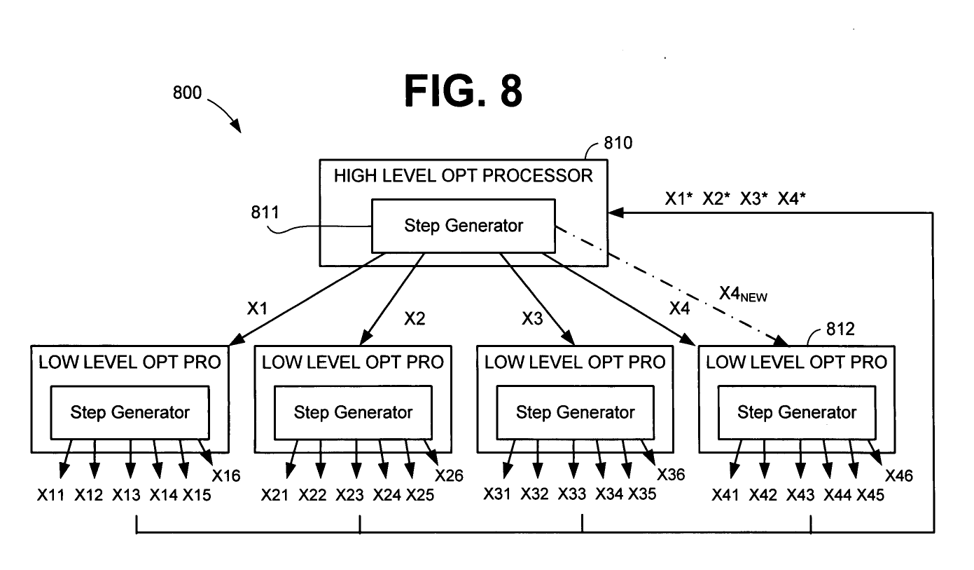

The step generator output can be supplied to the output channel 120 as well as the input channel 118. This allows the step generator output to be routed to other optimization processors to serve as their initial starting points (see, for example, FIG. 8). These other processors then perform optimization based on the different starting points.

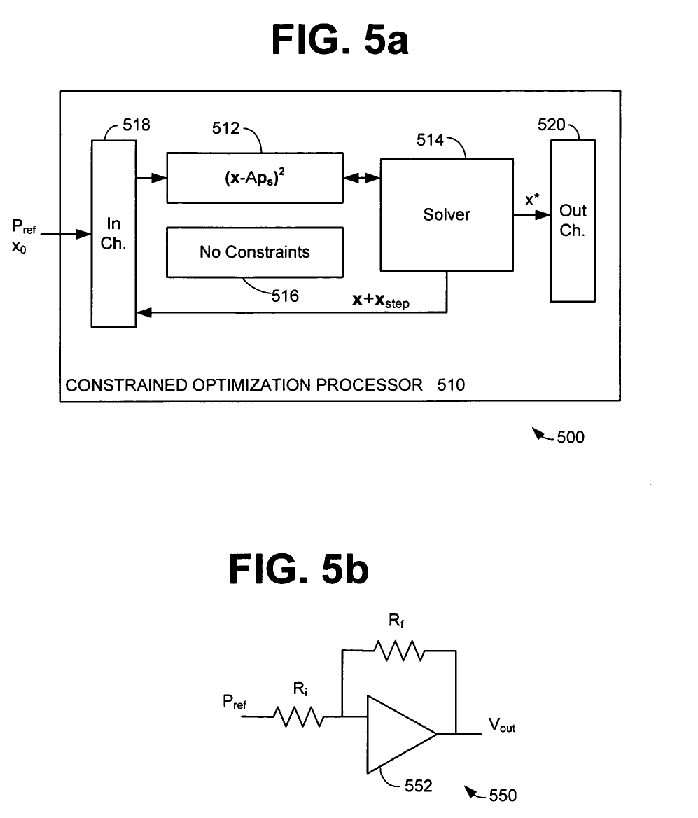

FIGS. 5-9 illustrate five systems that include optimization processors. These examples are not limiting to the present invention, but simply illustrate the power and utility of the optimization processors.

Reference is made to FIGS. 5a and 5b. FIG. 5a illustrates a system 500 including a constrained optimization processor 510 that is configured as an operational amplifier with resistance feedback, and FIG. 5b illustrates an electrical equivalent 550 of the system 500. An analog input signal p_{ref} is sampled by the input channel 518 of the optimization processor 510, and each sample pₛ is supplied to an objective function evaluator 512. The objective function evaluator 512 is programmed to evaluate the objective function (x−Apₛ)², where A is the amplifier gain (A=−R_{f}/Rᵢ). The objective function (x−Apₛ)² is initially evaluated at x=x₀, and the solver 514 updates the state vector x until an optimal value x* is found. In this example, the optimal value x* represents the output voltage (Vₒᵤₜ) of the operational amplifier 552. The state vector x is updated until x=Apₛ or until time runs out (e.g. time runs out when the input signal p_{ref} is sampled again). For a quadratic, a Newton's method will find the optimum point in a single iteration.

In the optimization processor 510 of FIG. 5a, no constraints are evaluated. However, the constraints function evaluator 516 of the optimization processor 510 could be programmed with constraints that, for example, would prevent the optimization processor 510 from over-ranging or slewing too fast by having a constraint x<xₘₐₓ or dx/dt<vₘₐₓ respectively. Ordinary op amps would not provide such constraint satisfaction without further design. Implementation of such constraints would be hardwired and would require significant effort and familiarity with the system to successfully alter them. The constraint and the solution are intertwined. In the optimization processor 510, in contrast, the constraint is explicitly incorporated in a well defined location and the constraint solution is isolated from the means for obtaining the optimum. Hence, in a product where the initial designer has moved on, the optimization processor 510 could be easily be modified by a new designer.

Thus, the function of the widely used operational amplifier can be implemented and greatly enhanced by the optimization processor 510. The optimization processor 510 can be used in phase locked loops, automatic gain control circuits, constant current and voltage sources, filtering, and numerous other applications in a similar manner. The optimization processor 510 can be used in systems such as audio systems, radios, and televisions. Unlike the usual feedback op-amp configuration, the optimization processor 510 allows constraints to be readily incorporated.

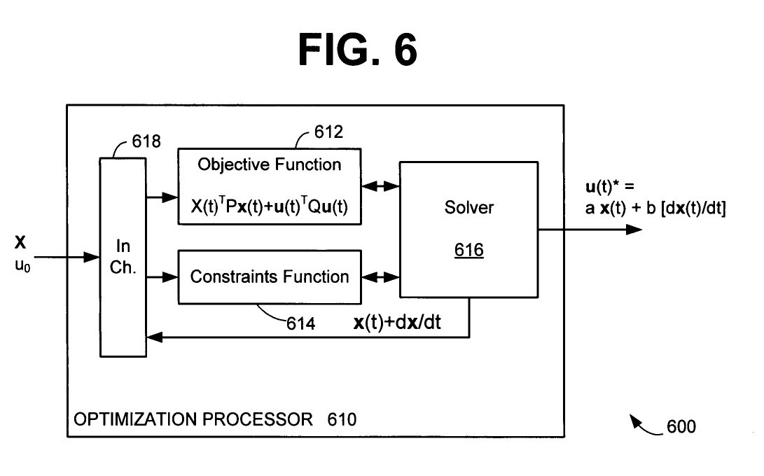

Reference is made to FIG. 6, which illustrates a system 600 including an optimization processor 610 that is configured as a proportional-derivative control. The processor 610 receives an input signal X, which is sampled in the input channel 618. The objective function evaluator 612 evaluates the objective function, which is given by the quadratic form X(t)^{T} PX(t)+u(t)^{T}Qu(t), where P is a positive symmetric 2×2 matrix, Q is a number, u(t) is the control output state and the state vector is X(t)=[x(t) dx(t)/dt]^{T}. In the case of no constraints, the optimal solution has the form u(t)*=ax(t)+b dx(t)/dt. This solution corresponds to a PD controller where the gains a and b are determined by P and Q. The real time output u(t)=a x(t)+b [dx(t)/dt].

The objective function evaluator 612 starts with an initial guess u₀ or a series of initial guesses, and generates a currant value of the objective function. Using one of the algorithms in FIGS. 4a-4e, the solver 616 computes values of df/dx and uses these values to compute promising directions for the next steps. The state vector u(t) is updated until an optimal solution is found (e.g., the objective function changes converged to a local minimum, allowable time expired).

The constraints function evaluator 614 can be configured (e.g., programmed at setup time or run time) with any constraints on the control or the state. If the constraints are active, then the optimization processor 610 becomes a constraint- aware PD controller. Examples of constraints may include rate of change and constraints related to overshoot, delay, and rise time. If, during control of the system 600, the system 600 is hanged either intentionally or because of malfunctions, the constraints function and/or optimization function can be re-programmed to reflect the new system.

Consider a first example, in which the system 600 further includes a boiler, and wherein the optimization processor 610 controls the temperature of the water inside the boiler. The temperature is represented by x(t). The constrained optimization processor 612 controls the temperature x(t) through the current u(t).

Consider a second example in which the system 600 includes a group of boilers, which provide hot water to an industrial complex. Each boiler is controlled by an optimization processor 610. The objective and constraints function evaluators 612 and 614 of the optimization processors 610 are programmed on the condition that water temperature is increased by all of the boilers in the group. If one of the boilers fails, this condition fails. However, the system 600 can adapt to this malfunction without replacing the entire controller. The objective and/or constrains function evaluators 612, 614 can simply be reprogrammed to compensate for the failed boiler (e.g., a constraint on maximum boiler temperature is increased).

The size and cost advantages of the optimization processors 610 become apparent in this second example. The system 600 enables a more robust and fault-tolerant mode of programming because changes in the operating environment, changes in goals, and changes in capabilities can be accommodated simply by re-programming the constraints.

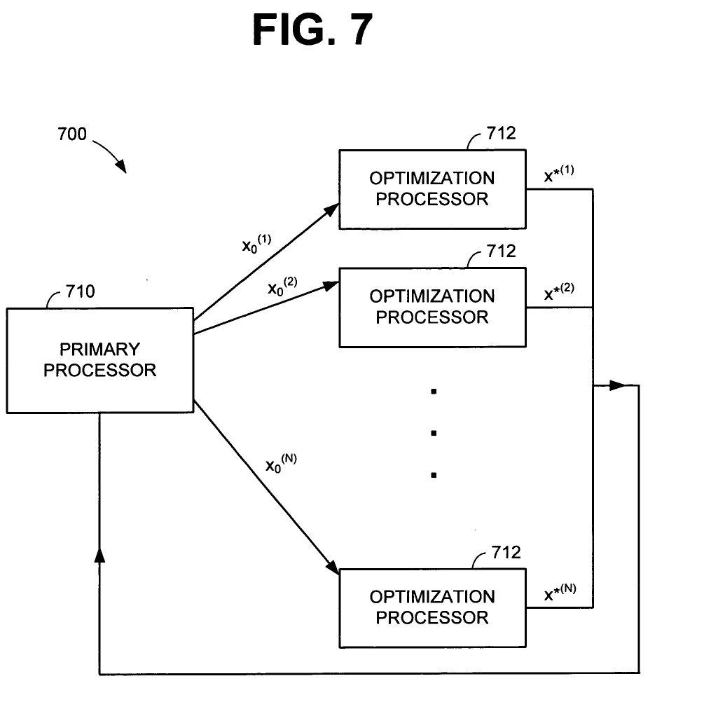

FIG. 7 illustrates a system 700 for finding a global solution. For example, the system 700 could find global extrema of an objective function. The system 700 includes a primary processor 710 and a cluster of secondary optimization processors 712. The secondary optimization processors 712 are programmed with the same objective function. The primary processor 710 sends different starting points to the secondary optimization processors 712. Each secondary optimization processor 712 generates a local optimal solution, and supplies the optimal solution back to the primary processor 710. The primary processor 710 examines the different optimal solutions (x*⁽¹⁾ to x*^{(N)}), and generates a new group of initial guesses. For example, the primary processor 710 could use either a Nelder Mead simplex method or a simulated annealing method implemented to be the driver for the global minimum solver. The system 700 can find a near optimal minimum in a problem having many local minima.

In some embodiments, the primary processor 710 may be a general purpose computer. In other embodiments, the primary processor 710 may be a specialized processor such as an optimization processor. In some embodiments, the optimization processors 712 could be programmed to use specific solver algorithms.

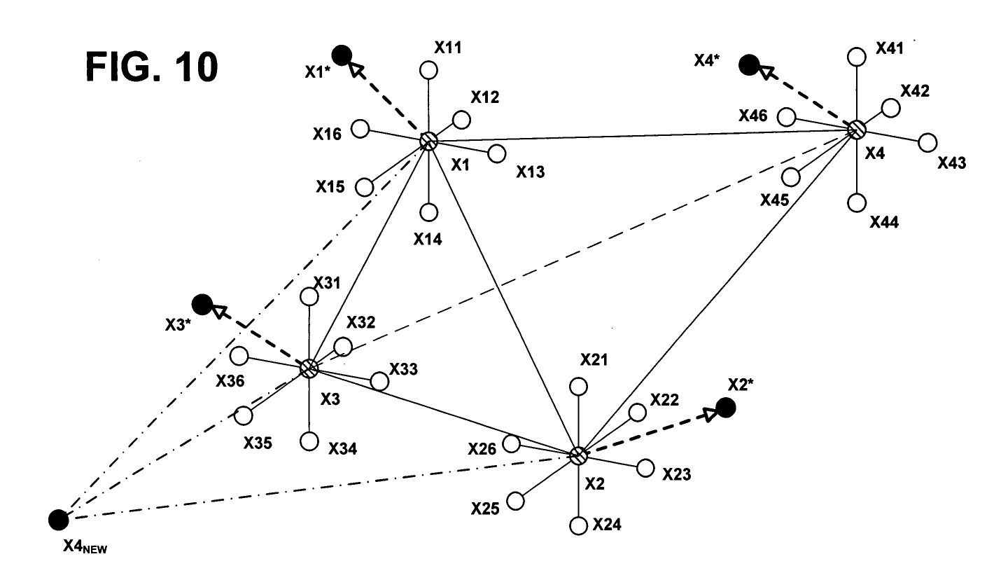

FIG. 8 illustrates a system 800 in which the step generators of different optimization processors are linked in a hierarchical fashion to create an even more powerful global local minimum solver. A primary processor 810 includes an optimization processor. A step generator 811 of the primary processor 810 farms out function evaluations X1, X2, X3 and X4 to secondary processors 812 for parallel optimization. The primary processor 810 generates a simplex. Each secondary processor 812 then performs a local minimization of each simplex vertex using a Newton-gradient stencil. The locally optimal values, X1*, X2*, X3*, and X4* for each simplex vertex are then reported back to the primary processor 810, which uses these locally optimal simplex values in a Nelder Mead to make a new simplex step (X4_{NEW}). This hierarchical implementation of both a Nelder Mead method and Newton method is able to locate near global minimum values without getting trapped in local minima. The algorithm implanted by the system 800 is illustrated in FIG. 10.

Nearly all stencil patterns (i.e., optimization routines) involve parallel computations of objectives and constraints for nearby points. These calculations may be performed in parallel and may be pipelined as will. SIMD is very useful for constrained optimization processors that operate in groups. Each subprocessor would be a classic case of an SIMD processor. Also, programming the sub processors would be a simple case of broadcast programming. The same program would run on each secondary processor.

Thus, the systems of FIGS. 7 and 8 incorporate a number of constrained optimization processors working in concert to obtain a much more rapid solution to the larger optimization problem.

The optimization processor can form a building block in a larger, more complex system. A group of optimization processors can be used in systems that solve rapid multidimensional, constrained optimization problems, such as a model predictive control for controlling robots and complex industrial processes.

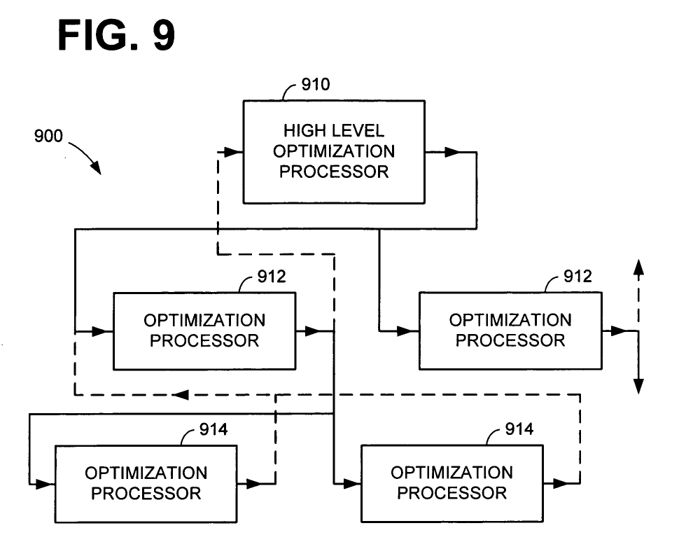

Reference is now made to FIG. 9, which illustrates a system 900 for solving rapid multidimensional, constrained optimization problems, such as a model predictive control for controlling robots and complex industrial processes. The system 900 includes, without limitation, three levels of optimization processors 910, 912 and 914. Solid Lines in FIG. 9 indicate a downward flow of information, and dashed lines indicate an upward flow of information. The highest level processor 910 may provide instructions for the overall goal and path planning. Parent processors set the optimization functions and constraints for their children. The children provide optimal solutions and constraint violations to their parents, while setting goals for their children For example, in the case of a robotic arm, the high level processor 910 can parcel out the goals of end effector pose (position and orientation) to the lower level processors 912 to accomplish the optimization tasks such as getting various joints to various positions that permit a reasonable solution consistent with any constraints.

The optimization processors allow for crisp discrete changes in control systems. The issue of crisp or discrete changes versus continuous changes is important in control of complex systems. A proportionate response and small actuation are desirable for small errors from the desired position, while for large errors, a large actuation effort is needed to get to the desired point as soon as possible. Consider the example of a thermostatically controlled heating system. The system might have a control law that says if <Temperature is less than the desired temperature> then <turn on the heater> else <turn off heater>. The output of such a test namely the action as a function of the inputs namely the <condition> is discrete. In the heating system example, the heating action goes from completely on to off as the temperature changes a few degrees around the desired temperature. Using optimization, the same condition could be expressed as minimizing the error between the desired and actual over a period of time. The system could then be made so that the response was proportionate thereby minimizing erratic and abrupt changes. However, discontinuous abrupt changes can still be enforced, if needed, by using ‘hard’ constraints.

Although several embodiments of the present invention have been described and illustrated, the present invention is not limited to the specific forms or arrangements of parts so described and illustrated. Instead, the present invention is construed according to the following claims.

1. A specialized processor comprising:
an objective function evaluator responsive to a state vector; and
a solver, responsive to an output of the evaluator, for finding an optimal solution to the state vector.

2. The processor of claim 1, wherein the objective function evaluator makes multiple evaluations of the state vector as the stage vector is updated; and wherein the solver finds the optimal solution from the multiple evaluations.

3. The processor of claim 2, wherein the objective function evaluator includes pipelined hardware for evaluating the objective functions for different values of the state vector.

4. The processor of claim 1, comprising a first dedicated circuit including the objective function evaluator; and a second dedicated circuit including the solver.

5. The processor of claim 1, further comprising a constraint function evaluator for determining whether the state vector violates any constraints; and wherein the solver finds the optimal solution subject to any constraints.

6. The processor of claim 1, wherein the objective function evaluator includes a circuit for performing automatic differentiation.

7. The processor of claim 6, wherein the solver stores previous evaluations of the state vector; and wherein the solver computes and derivatives of the state vector; and wherein the objective function evaluator uses the evaluations and derivatives to evaluate an objective function.

8. The processor of claim 1, comprising a step generator for updating the state vector.

9. The processor of claim 8, wherein the step generator generates a step size and adds the step size to the state vector.

10. The processor of claim 9, wherein the step generator is programmed with different algorithms for finding the step size.

11. The processor of claim 10, wherein the step generator shifts between algorithms by changing a step generation step stencil.

12. The processor of claim 11, further comprising means for determining when an algorithm is trapped, and causing the step generator to change the step stencil when the algorithm is trapped.

13. The processor of claim 11, wherein the solver includes a random number generator for generating the step stencil.

14. The processor of claim 1, wherein an objective function of the evaluator is programmable at run time.

15. The processor of claim 1, configured as an operational amplifier.

16. A control system comprising at least one processor of claim 1.

17. The system of claim 16, wherein a plurality of processors receive different guesses but solve the same constrained optimization problem.

18. The system of claim 17, further comprising a controller for selecting a solution from one of the processors.

19. The system of claim 17, wherein the constrained optimization problem is multi-dimensional; and wherein the outputs of processors at one level dimension are used as inputs by processors at a lower level.

20. The system of claim 17, wherein the processors receive constraints and objective input parameters from different sources.

21. A specialized processor comprising:
means for evaluating an objective function with respect to an input vector;
means for evaluating a constraint function with respect to the input vector; and
means for finding at least one optimal solution of the objective function subject to the constraints.

22. A processor specialized to solve a constrained optimization problem.

23. A specialized processor comprising:
an objective function evaluator responsive to a state vector; and
a step generator for updating the state vector in response to the function evaluator.

24. A system comprising a plurality of processors that are specialized to perform optimization problems, wherein inputs and outputs of the processors are interconnected.

25. The system of claim 24, wherein the processors are interconnected to find a global solution.

26. The system of claim 24, wherein the processors are interconnected to provide a hierarchical implementation of both a Nelder Mead method and Newton method.

27. The system of claim 24, wherein the processors are interconnected such that parent processors set optimization functions and constraints for their children; and wherein children provide optimal solutions and constraint violations to their parents, while setting goals for their children.
